(19) United States
(12) Patent Application Publication
(10) Pub. No.: US 2005/0125770 A1
(43) Pub. Date: Jun. 9, 2005

(54) Method and system for surveying and modeling a site

(76) Inventors: Stephane M. Arsenault, Beaconsfield (CA); Gerard Lamarre, Terrebonne (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/705,867

(22) Filed: Nov. 13, 2003

(51) Int. Cl. G06F 9/44

(52) U.S. Cl. 717/104; D10/46

(57) ABSTRACT

A method of using a computer to control a survey measurement device for determining a virtual location of a virtual model object corresponding to the feature. Initially, the survey measurement device is directed at the feature. Then the computer issues a command to the survey measurement device to determine coordinates of the feature relative to the survey measurement device and receives from the survey measurement device the relative coordinates of the feature. The computer then records the relative coordinates into a corresponding virtual location in the model and establishes at the virtual location the virtual object corresponding to the feature.

### FIELD OF THE INVENTION

The present invention generally relates to a surveying system, and more specifically, to a field surveying system and method that models the surveyed site.

### BACKGROUND OF THE INVENTION

In recent years, the advancement of field survey equipment has improved productivity and increased reliability by automating numerous tasks that field surveyors have traditionally performed manually. Today, surveyors electronically collect and store measurements for desired points through a survey measurement device, such as a total station. Such survey measurement devices are also measure horizontal and vertical angles, and include an electronic distance measurement device (EDM). A drawing of the survey site is then produced, either manually or using a software tool, such as a computer aided drafting (CAD) application. Typically, the data acquired by the survey measurement device must be transformed into a suitable format and transferred to a computer. Most conventional methods of data transfer to a CAD application involve downloading the captured information from the survey measurement device to the CAD application off site, or transferring the information to an intermediate storage medium, and loading the information from the storage medium to a computer running the CAD application. The information must then be manipulated to draft a plan of the surveyed site.

For example, U.S. Pat. No. 5,091,869 to Ingram et al. discloses a computer-integrated building survey system where survey data is collected in the field and recorded in a data collector according to identifiers supplied by the operator. Once the field measurements have been recorded, the field data is downloaded to a computer running custom software. The custom software transforms the field data to a data exchange format (.dxf) file, which can then be used within a CAD application. Transformation of the field data to a .dxf file requires significant reformatting by the operator. While the method taught by Ingram et al. permits survey data to be collected electronically in the field, and eventually processed within the CAD application, numerous transfer, transformation and manual reformatting steps must be performed by the operator.

Methods and systems such as that taught by Ingram et al. require that an operator first take the desired measurements at the survey site, and then download the data to a computer running a CAD application. These steps generally occur at separate locations, thus precluding direct verification of the measured points without re-deploying the operator to the survey site.

Devices and methods have been disclosed for transferring physical measurements directly from a survey measurement device to a computer running a CAD application at the survey site. For example, U.S. Pat. No. 5,337,149 to Kozah et al. discloses an interior surveying system that permits a more direct interface with a computer running a CAD application. The method taught by Kozah et al. uses an EDM and a microcontroller to measure points and provide polar coordinates of the measured points to a computer running a CAD application. The CAD application then transforms the polar coordinates to a usable format that permits manipulation of the measured points in the CAD environment. Unlike Ingram et al., the method and system taught by Kozah et al. does not require that the operator manually reformat the data before it is fed to the CAD application. However, Kozah et al. does not enable the operator to dynamically make changes to the CAD-generated model of the surveyed site during the surveying process, nor to dynamically verify the overall accuracy of the model.

Thus, although known systems and methods permit communication between a survey measurement device and a CAD application, such communication is not bi-directional and does not permit an operator to send control commands from the CAD application to the survey measurement device for quality assurance and performance purposes. Data communication in the prior art is limited to uni-directional data flow from the survey measurement device to the CAD application. There is no suggestion in the prior art that a CAD application can be used to trigger operation of a survey measurement device. Nor does the prior art permit direct verification of measured points or closure through interaction with the survey plan modeled by the CAD application.

Thus, it is desirable to provide a method and system that permits bi-directional interaction between a survey measurement device and a CAD application. It is further desirable to provide a system and method that permits an operator to interact directly with the survey measurement device through a CAD interface, and that permits on-site verification of measured data within the CAD environment.

### SUMMARY OF THE INVENTION

The present invention relates to a system and associated method for producing a model of a survey site. The present invention conveniently allows an operator to control a survey measurement device such as a total station, by transferring data bi-directionally between the survey measurement device and the CAD software.

According to a first aspect of the present invention, there is provided a surveying system for generating a computer model of a physical site. The survey system comprises a survey measurement device for determining a location of a selected feature relative to the survey measurement device; and a computer-aided drafting (CAD) module for modeling the physical site. The CAD module includes a CAD application program installed on a computer for receiving from the survey measurement device data related to the location of the selected feature. The CAD application program then creates a corresponding object in the computer model. A bi-directional communication interface between the CAD application program and the survey measurement device communicates commands from the CAD application program to the survey measurement device and communicates the data related to the location of the selected feature from the survey measurement device to the CAD application program.

In a further aspect, the present invention provides a CAD module for the surveying system described above. The CAD module comprises a CAD application program for creating a model of a site, and a bi-directional communication interface for enabling the CAD application program to initiate measurement of a location of a feature at the site by the survey measurement device and for enabling the survey measurement device to communicate data related to the location of the feature to the CAD application program. The model includes objects representing features of the site.

Preferable features of the CAD application program can include means for assigning attributes to the objects, and a graphical user interface (GUI) that permits objects to be selected in the model by an operator. The bi-directional communication interface preferably includes means responsive to operator interaction with the GUI. Where the CAD application program includes means for creating layered models of the site, selection of an object can determine attributes of the object in accordance with predetermined layer and object properties.

In yet another aspect, the present invention provides a surveying method using a survey measurement device connected to a CAD module. The method comprises steps of sending a trigger command from the CAD module to the survey measurement device to initiate measurement of a location of a feature at a survey site by the survey measurement device; receiving from the survey measurement device the location of the feature; and establishing, at a corresponding location in a model of the site, an object corresponding to the feature.

Where the survey measurement device is robotically-controlled, the method can further include sending a positioning command from the CAD module to the survey measurement device to cause the survey measurement device to be directed at the feature. This positioning command can be initiated by operator interaction with a graphical user interface associated with the CAD module. Preferably the present method permits attributes to be associated with the object, and permits on-site labelling of the object. The method can also include error correction routines.

In another aspect, the present invention provides a method of marking features at a site corresponding to objects in a computer model. The method comprises selecting, through interaction with a graphical user interface associated with a computer-aided drafting (CAD) module, an object in a computer model of the site pre-loaded into the CAD module, transmitting real world coordinates of the feature from the CAD module to a survey measurement device; commanding the survey measurement device to indicate a location of the feature; and marking the location.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached figures, wherein:

FIG. 1 illustrates a measurement taken by a survey measurement device at a survey site;

FIG. 2 illustrates a surveying system according to the present invention;

FIG. 3 illustrates an embodiment of a survey measurement device according to the present invention;

FIG. 4 illustrates a surveying method according to the present invention; and

FIG. 5 further illustrates the method of the present invention.

### DETAILED DESCRIPTION

Generally, the present invention relates to a system and an associated method for producing a model of a survey site. By model, we refer to a plan, drawing or other representation, including a computer generated model in two or three dimensions.

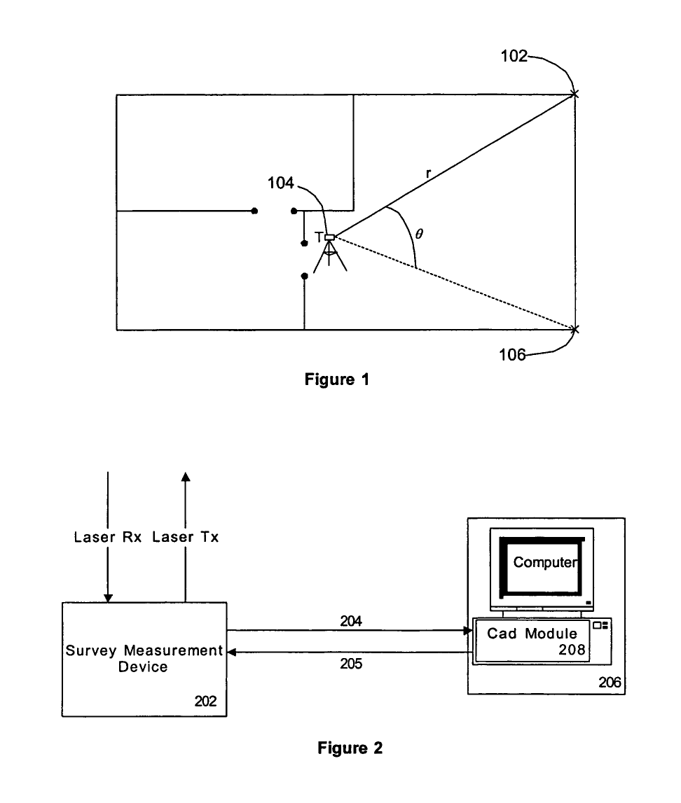

In conventional surveying, an operator typically uses a manual measurement device, such as a theodolite and measuring device, or alternatively a total station which includes an EDM, to determine the location of a feature or point at a survey site. The operator sights the feature and determines the location of the feature relative to the measuring device. The position is typically first established in polar coordinates. For example, referring to FIG. 1, the measurement, in two dimensions, of a feature 102 from the measurement device 104 relative to a reference point 106, consists of distance r and angle θ. If the measurements are taken in three dimensions, a further angle φ is necessary to properly locate a measured point. After determining the location of the feature relative to the reference point 106, the operator records the coordinates along with an identification of the feature, and then proceeds to the next measurement. Once all desired measurements are made, the operator typically goes offsite to convert the polar coordinates into corresponding Cartesian coordinates, and prepares a plan of the survey site manually or through use of a computer running a CAD application.

Referring to FIG. 2, a system for surveying and modeling a site according to the present invention is shown. The system allows bi-directional exchange of data between a survey measurement device 202 and a CAD module 208 installed on a general-purpose computer 206. Alternately, the CAD module can be installed on a single, or special, use computer platform. As used herein, computer is intended to include both general purpose and special use computing devices capable of supporting the CAD module. The computer will generally include any necessary operating system software, and input and output devices, such as a keyboard, a mouse, a display screen, and serial and parallel communication ports. The bidirectional communication is enabled by a bi-directional communication link 204, 205. The bi-directional communication link 204, 205 can be wired or wireless. In effect, the survey measurement device 202 is treated as a peripheral device under the control of the CAD module 208. This is in contrast to the prior art in which, conceptually, the survey measurement device was stand-alone or the computer was a write-only storage device of the survey measurement device connected by a uni-directional data communication line.

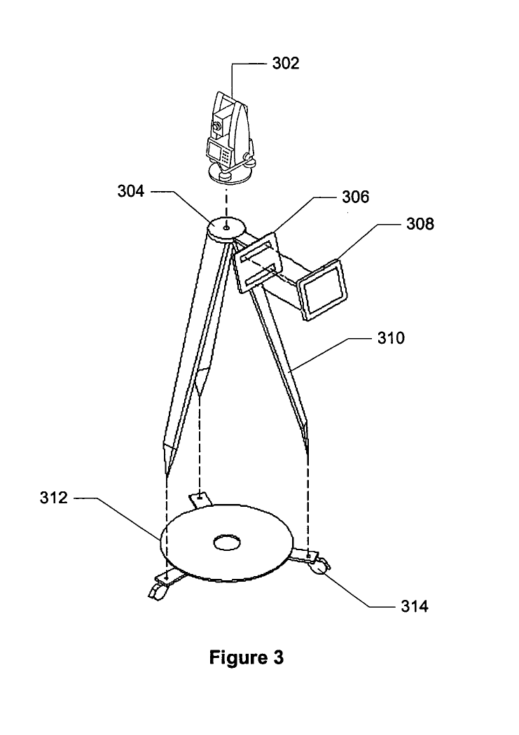

The present invention is not limited to any particular survey measurement device. One embodiment of a survey measurement device according to the present invention is shown in FIG. 3. The survey measurement device comprises a total station 302, such as those manufactured by Leica Geosystems Inc. Another example of a survey measurement device is a handheld laser distancemeter, such as those in the Leica Disto™ line of products manufactured by Leica Geosystems Inc. These devices can be handheld, mounted on a support structure, or placed on a suitable surface. Another alternative survey measurement device is a three dimensional laser scanner for high-definition surveying (HDS), such as the HDS 3000 available from Leica Geosystems Inc. The chosen survey measurement device preferably measures the position of features in a two or three dimensional polar coordinate system relative to the measurement device, and then transforms the polar coordinates into corresponding Cartesian coordinates. This transformation need not necessarily be performed by the survey measurement device and, according to an alternative embodiment, the CAD module receives the unprocessed polar coordinate measurements and does an appropriate transformation as required for the computer modeling application. A further alternative survey measurement device is a global positioning system (GPS) based measuring device. GPS-based devices directly provide measurements of a feature in Cartesian coordinates. In any event, each feature at the site is stored as an object in a computer model. The object has attributes, including its measurements. For example, the attributes of an object can include an identification of the feature/object, its Cartesian coordinates, its polar coordinates as determined by the survey measurement device and any other desired attributes chosen by the operator or required to define the attributes of the object.

In the illustrated embodiment, the total station 302 is mounted on a support structure such as an adjustable tripod 310. For greater mobility, the tripod 310 can be mounted on a rolling base 312 having wheels 314. At the top of the tripod 310 is a cushion plate 304 to which the total station 302 can be removably attached. The support structure also includes an attachment plate 306 to which a computer 308 can be attached. Preferably, the computer 308 is a compact integrated portable unit, such as a tablet personal computer (Tablet PC). Preferably, the computer 308 includes an interactive screen or touch screen, such as those found on Tablet PCs. This allows the operator to interact directly with the model displayed on the screen and to use a graphical user interface (GUI) including, for example, drop-down menus, slides and other controls.

A bi-directional data communication channel, either wired or wireless, connects the computer with the survey measurement device. This communication channel enables the computer to send information, such as commands, to the survey measurement device 302, and to receive information, such as measurements, from the survey measurement device 302. Preferably, the communication channel allows both the computer and the survey measurement device to send and receive data synchronously.

The computer 308 is loaded with suitable software tools such as a CAD application program, an example of which is AutoCad®, published by Autodesk Inc. In a presently preferred embodiment, the CAD application is customized to include a bi-directional communication interface that enables the CAD application to receive data from, and transmit data to, the survey measurement device. For example, macros or routines installed in the AutoCad® environment, using a suitable software platform supported by the CAD application or the operating system, such as VBA, C++ or Object ARX, can be used to implement such an interface. Implementation of a suitable communication interface will be well understood by those of skill in the art, and will depend on the survey measurement devices it is desired to support, the libraries associated with the CAD application and software platform used. The combination of the CAD application and the communication interface form the CAD module illustrated in FIG. 2. According to a preferred embodiment, all of the necessary software tools and routines are embedded and fully integrated into the CAD application to permit direct communication with the survey measurement device, without resorting to further intermediate storage, files or software.

Communication between the CAD module and the survey measurement device is preferably initiated through the GUI in the CAD module. This permits the present invention to be used interchangeably with a number of different survey measurement devices, as desired by the operator. For example, the main structural features of a site, such as the location of the outside walls in a building, can be conveniently and accurately determined by a tripod mounted survey measurement device, such as the total station of FIG. 3. For measurement of smaller features such as the location of alcoves, it can be more practical to use a hand-held survey measurement device. To enable this flexibility, it is preferable that both devices interface with the CAD module in a manner that is transparent to the operator. Preferably, the CAD module is capable of detecting the survey measurement device being used and provides appropriate functionality to the operator in accordance with the detected device.

The CAD module, preferably with a GUI, in conjunction with a suitable input device such as a touch screen or pen screen, enables the operator to interact with the model to construct and enhance the model and also to direct and control the survey measurement device. This results in a single point of focus and control from which the operator can work, minimizing the possibility of errors and distractions. In addition, the quality of the model is greatly improved because the operator's efforts are directed to interactively constructing the model which can be immediately verified by comparing it with the site while on-site. This functionality enables the operator to immediately begin constructing the computer model of the survey site, prior to having taken all the measurements. Accordingly, the operator of the present invention has the great advantage of being able to construct and verify the computer model at the site, feature by feature.

Another important feature of the present invention relates to the management of errors. In accordance with conventional surveying practice, reference points can be established, and closure can be ascertained by ensuring that the last reference point corresponds to the first reference point. If these two points do not coincide, there is an indication that an error has been introduced into the measurements. The usual practice is to adjust all measurements so as to distribute the accumulated error over the entire model. This is conventionally performed offsite, either manually or with automated assistance. However, the present system contains a database of each measurement, including the attributes of each model object and the reference point or points from which each individual measurement is based. Accordingly, the system can automatically distribute any error arising from the closure requirement without effort by the operator.

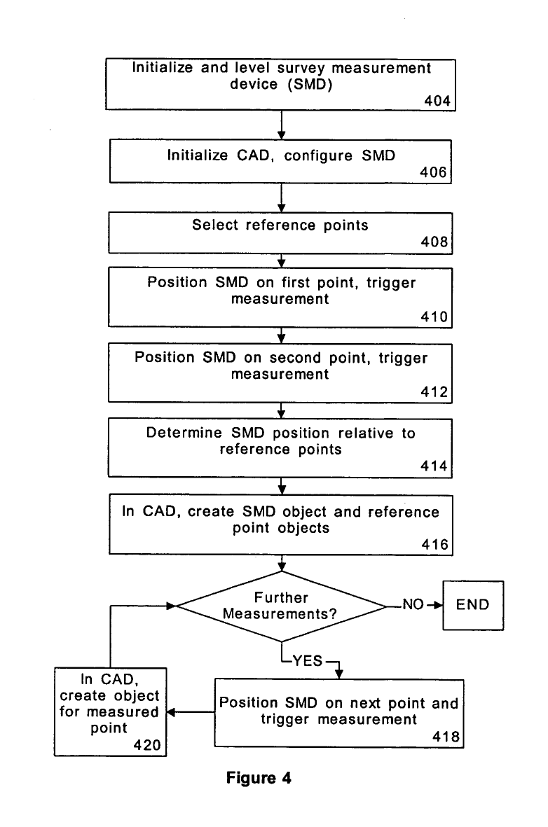

FIG. 4 illustrates a method of surveying and modeling a site according to an embodiment of the invention. Initially, the survey measurement device is initialized and levelled at the site (404). If necessary, the CAD module is initialized and any necessary configuration setup data is transferred to the survey measurement device (406). Next, two features, or points, are selected (408) and the survey measurement device is sighted, or otherwise positioned, and triggered by the CAD module to measure the first point (410), after which it is sighted and triggered to measure the second point (412). The CAD module then locates the survey measurement device relative to the reference points (414) and objects are created in the model corresponding to the location of the survey measurement device and the reference points (416). Measurements are then made of additional features at the survey site, by appropriately sighting and triggering the survey measurement device (418). The CAD module stores and preferably displays an object for each additional feature (420). The method terminates when no further features require measurement, and data relating to all desired features has been collected and represented in the computer model as objects.

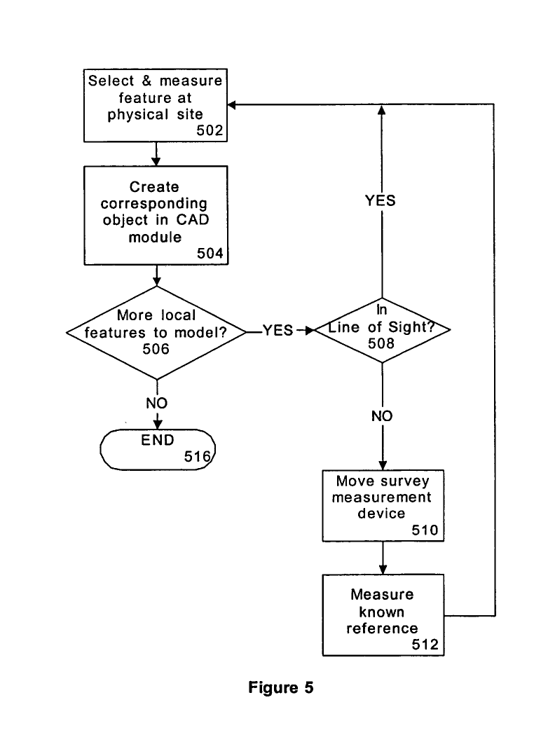

FIG. 5 more generally illustrates the method of the present invention. First, a feature is selected and a measurement is taken to record the position of the feature using the survey measurement device (502). In the two dimensional example illustrated by FIG. 1, the position of the feature is determined by the distance recorded and by the angle defined by the line from the survey measurement device to the selected feature and the line from the survey measurement device to the reference point. The survey measurement device communicates this information along with an identification of the feature, via the communication link or wireless connection, to the CAD module, where an object corresponding to the feature is created in the model (504). At the next step, it is determined whether additional features are to be included in the model (506). If no additional features are required then the modeling is complete (516).

If one or more additional features are required, then the next feature is chosen (514). If the next feature is in the line of sight of the survey measurement device or can otherwise be measured without relocating the survey measurement device (508), then the method returns to step 502. If the next feature is not in the line of sight of the survey measurement device, or it is desirable to move the survey measurement device closer to the next feature, then the survey measurement device is moved to a new position (510). At the new position, measurements are made of a known line of a reference having a corresponding object in the model to determine the survey measurement device location relative to the model (512). The method then returns to steps 502.

When a feature is transmitted from the survey measurement device, the CAD module enables the operator to use, for example, a drop-down menu appropriate to the task at hand, to identify and define attributes of the object in the model. Attributes can include comments provided by the operator, instructions to other persons, choice of color, related text, legend markings, etc. Preferably, the attributes are predetermined for specific object choices, to prevent operator entry error. If the CAD module is enabled to prepare separate layers, then choice of a particular object can also determine the layer in which the object is placed. For example, if an operator chooses a sprinkler object, it will automatically be placed in the plumbing layer of the model. Alternately, the operator can choose an appropriate layer in the model, and will only be presented with objects suitable to that layer. Preferably, the object is automatically assigned an identifier, such as a numeric identifier, and the operator is prompted by the CAD module to label the object, if necessary. Preferably, the operator is free to modify an automatically assigned qualifier if it is inappropriate or confusing. Alternatively, the object can be labelled at a later time.

Preferably, the computer performs an integrity check on the received data as it is received. If the check determines that the received data is unacceptable, for example due to error, the computer can reject the data and/or alert the operator.

According to another embodiment of the present invention the survey measurement device can be a robotically-controlled total station, equipped with one or more motors capable of orienting the total station in the direction of a target feature. Preferably, the total station's robotics are also under the control of the CAD module. For example, the operator can select an object in the model and instruct the total station robotics to automatically position the survey measurement device to point to the target feature. It is further contemplated that the survey measurement device can include additional sensors, such as a charge-coupled device and associated software, to utilize robotic vision to identify the target feature or assist in orienting the survey measurement device.

The present invention is also well-adapted for staking out a site based on plans. In this mode of operation, the CAD module is loaded with a set of plans or CAD files for a site. The site is then staked out. Typically, the locations of physical features are marked at the site by using the survey measurement device to identify the physical location of each point. The operator selects an object or a set of objects in the computer model, preferably through interaction with the GUI. For example, in response to activation of a touch screen or other pointing device, the computer responds by sending suitable commands to the survey measurement device to locate the corresponding physical point or feature at the site. Staking out in this manner, the operator is not distracted by conversion of the measurements and locations of objects in the model to corresponding measurements and locations at the site. Since the operator is able to work from the model, the job is completed more quickly with less chance of error, since the operator can pay attention to the important features of the project, such as assessing the structural elements of the plan.

According to a method of staking out according to the present invention, the operator initially sets up reference points at the site corresponding to reference objects in the computer model. Next, the operator uses the GUI of the CAD module to select an object in the model for location of a corresponding feature at the site. The computer transmits the coordinates of the feature at the site to the survey measurement device by means of the bi-directional communication link, either in Cartesian coordinates or preferably in polar coordinates. The survey measurement device receives the coordinates of the feature and indicates the corresponding location at the site, for example, by sighting the device at the selected point using a laser or by some other suitable means. The operator then marks the location. If motorized and robotically enabled, the survey measurement device can automatically locate the site for the operator to mark. The operator then selects the next model object for marking at the site. Preferably, the system also permits the operator to select a plurality of objects in the model for the survey measurement device to locate. Preferably, the system queues up the different objects/features for staking in the most efficient order or in an order predetermined by the operator. This is preferably managed by an integral module of the CAD module which administers the queued up objects and determines sequencing and timing of the individual staking out tasks sent to the survey measurement device using the bi-directional communication link.

As will be understood by those skilled in the art, the present invention permits an operator to interactively model a survey site without requiring costly and disruptive return visits. In addition, the present invention enables the surveyor to survey more efficiently and effectively. Another feature of the present invention is the presence of an interactive interface, such as a graphical user interface, which enables the operator to communicate with the computer and, in particular, to interact with the model, to enhance the model, verify the feature measurements and, where necessary, send commands to and otherwise manipulate the survey measurement device. For example, according to one embodiment, once a model or part of the model is established the operator can use the graphical user interface to direct the survey measurement device or total device to a feature or prominent point by identifying the corresponding virtual point in the model. The actual measurement of the feature can be made by actuating or launching the survey measurement device through the user interface, and for example, typing in a command or selecting an action item from a drop-down menu.

The present invention further allows the computer to create a better model of the site by identifying and correcting errors on-site, minimizing errors arising from incorrectly identifying prominent points corresponding to a virtual location or vice-versa, reducing or virtually eliminating errors arising from incorrectly transferring measurements from the survey measurement device to the computer. In addition, the dynamic interaction between the operator and the model ensures that the results are the ones desired with greatly reduced possibility of unpleasant surprises away from the survey site. This is a result of the operator's ability to build the model and interact with the model while simultaneously performing a visual check of the site to ensure that all the features needed appear in the said model.

The above-described embodiments of the present invention are intended to be examples only. Alterations, modifications and variations can be effected to the particular embodiments by those of skill in the art without departing from the scope of the invention, which is defined solely by the claims appended hereto.

1. A surveying system for generating a computer model of a physical site, the system comprising:
a survey measurement device for determining a location of a selected feature relative to the survey measurement device; and
a computer-aided drafting (CAD) module for modeling the physical site, the CAD module, including a CAD application program installed on a computer for receiving from the survey measurement device data related to the location of the selected feature, and for creating a corresponding object in the computer model, and a bidirectional communication interface between the CAD application program and the survey measurement device for communicating commands from the CAD application program to the survey measurement device and for communicating the data related to the location of the selected feature from the survey measurement device to the CAD application program.

2. The surveying system of claim 1, wherein the computer includes an interactive display for enabling the operator to interact with the model at the survey site and enabling the operator to control the survey measurement device by use of a graphical user interface associated with the CAD module.

3. The surveying system of claim 1, wherein the bidirectional communication interface includes a wireless link.

4. The surveying system of claim 1, wherein the bi-directional communication interface includes a cable link.

5. The surveying system of claim 1, wherein the survey measurement device comprises a total station.

6. The surveying system of claim 1, wherein the survey measurement device comprises a hand held laser measurement device.

7. The surveying system of claim 1, wherein the survey measurement device comprises a global positioning system based device.

8. The surveying system of claim 1, wherein the survey measurement device comprises a high definition scanner.

9. The surveying system of claim 1, wherein the location of the selected feature and the corresponding object are represented in two dimensions.

10. The surveying system of claim 1, wherein the location of the selected feature and the corresponding object are represented in three dimensions.

11. A computer-aided drafting (CAD) module for a surveying system, the surveying system having a survey measurement device connected to a computer running the CAD module, the CAD module comprising:
a CAD application program for creating a model of a site including objects representing features of the site; and
a bi-directional communication interface for enabling the CAD application program to initiate measurement of a location of a feature at the site by the survey measurement device, and for enabling the survey measurement device to communicate data related to the location of the feature to the CAD application program.

12. The CAD module of claim 11, wherein the CAD application program includes means for assigning attributes to the objects.

13. The CAD module of claim 12, wherein the CAD application program includes a graphical user interface (GUI), and the bi-directional communication interface includes means responsive to operator interaction with the GUI.

14. The CAD module of claim 13, wherein the GUI includes means for selection of objects in the model by an operator.

15. The CAD module of claim 13, wherein the CAD application program includes means for creating layered models of the site.

16. The CAD module of claim 15, wherein operation of the selection means determines attributes of an object in accordance with predetermined layer and object properties.

17. The CAD module of claim 11, further including means for calculating error in measured feature locations.

18. The CAD module of claim 17, further including means for distributing the error amongst a plurality of measured feature locations.

19. A surveying method using a survey measurement device connected to a CAD module, the method comprising steps of:
sending a trigger command from the CAD module to the survey measurement device to initiate measurement of a location of a feature at a survey site by the survey measurement device;
receiving from the survey measurement device the location of the feature; and
establishing, at a corresponding location in a model of the site, an object corresponding to the feature.

20. The surveying method of claim 19, wherein the survey measurement device is robotically-controlled, and further including a step of sending a positioning command from the CAD module to the survey measurement device to cause the survey measurement device to be directed at the feature.

21. The surveying method of claim 20, wherein sending the positioning command is initiated by operator interaction with a graphical user interface associated with the CAD module.

22. The surveying method of claim 19, further including associating attributes with the object.

23. The surveying method of claim 19, further including labelling the object.

24. The surveying method of claim 22, wherein labelling the object includes selection of an object identifier from a drop-down menu in a graphical user interface.

25. The surveying method of claim 19, wherein sending the command comprises using a graphical user interface to receive input from an operator and sending a corresponding command to the survey measurement device based on the received input.

26. The surveying method of claim 19, further including a step of determining an error in the measurement of the location of a feature.

27. The surveying method of claim 19, further including a step of determining a closure error.

28. The surveying method of claim 19, further including a step of distributing a determined error over all measured feature locations.

29. A method of marking features at a site corresponding to objects in a computer model, the method comprising:
selecting, through interaction with a graphical user interface associated with a computer-aided drafting (CAD) module, an object in a computer model of the site pre-loaded into the CAD module, the object corresponding to a feature at the site;
transmitting real world coordinates of the feature from the CAD module to a survey measurement device;
commanding the survey measurement device to indicate a location of the feature; and
marking the location.
